(19) United States
(12) Patent Application Publication
(10) Pub. No.: US 2011/0074637 A1
(43) Pub. Date: Mar. 31, 2011

(54) ANTENNA AND COMMUNICATION DEVICE

(75) Inventors: Naoki Sotoma, Tokyo (JP); Hideaki Shimoda, Tokyo (JP); Toshihiro Tsuru, Tokyo (JP)

(73) Assignee: TDK CORPORATION, Tokyo (JP)

(21) Appl. No.: 12/880,713

(22) Filed: Sep. 13, 2010

(30) Foreign Application Priority Data
Sep. 29, 2009 (JP) 2009-225412

(51) Int. Cl. H01Q 1/38; H01Q 9/04

(52) U.S. Cl. 343/700 MS

(57) ABSTRACT

An antenna includes a dielectric substrate and an antenna element, wherein the dielectric substrate has a mark on an outer surface, the mark having a lower relative permittivity than the dielectric substrate, the antenna element is formed from a FPC film, and the FPC film has an antenna electrode on one side and a flexible insulating film with an adhesive layer on the other side and is adhered to the outer surface of the dielectric substrate with a tip or bend of the antenna electrode aligned with the mark.

### BACKGROUND OF THE INVENTION

1. Field of the Invention

The present invention relates to an antenna and a communication device using the same.

2. Description of the Related Art

Antennas are essential for communication devices, and therefore a wide variety of antennas have been proposed and put to practical use. Among them, there is an antenna in which an antenna element formed from a FPC (flexible printed circuits) is employed and the antenna element is adhered to a dielectric substrate using adhesion of the FPC (for example, Japanese Unexamined Patent Application Publication No. 2007-274665).

Since the antenna element is formed from the FPC, an antenna electrode has a high patterning accuracy, thus making it possible to readily manufacture an antenna whose resonance frequency does not vary widely. In addition, since the antenna element can be obtained by simply adhering it to the dielectric substrate, it is easy to manufacture and assemble.

However, there is a problem that the resonance frequency varies with change in mounting position of the FPC on the dielectric substrate.

### SUMMARY OF THE INVENTION

It is an object of the present invention to provide an antenna which shows only a small variation in frequency characteristics with change in mounting position of antenna element formed from a FPC, and a communication device using the same.

In order to achieve the above object, an antenna according to the present invention comprises a dielectric substrate and an antenna element. The dielectric substrate has a mark on an outer surface, the mark having a lower relative permittivity than the dielectric substrate. On the other hand, the antenna element is formed from a FPC film. The FPC film has an antenna electrode on one side and a flexible insulating film with an adhesive layer on the other side and is adhered to the outer surface of the dielectric substrate with a tip or a bend of the antenna electrode aligned with the mark.

As described above, the antenna element is formed from a FPC film. The FPC film has an antenna electrode on one side and a flexible insulating film with an adhesive layer on the other side and is adhered to the outer surface of the dielectric substrate. Therefore, the antenna element has a high patterning accuracy, which makes it possible to realize an antenna which shows only a small variation in its resonance frequency. In addition, it can easily be manufactured by simply adhering the FPC to the dielectric substrate.

The antenna according to the present invention is characterized in that the dielectric substrate has a mark on an outer surface and the EPC film is adhered to the outer surface of the dielectric substrate with the antenna electrode aligned with the mark. With this configuration, the relative position of the antenna electrode to the dielectric substrate can be stabilized to realize an antenna which shows only a small variation in frequency characteristics with change in mounting position of a FPC.

When positioning by using the tip or the bend of the antenna electrode, the tip or the bend of the antenna electrode may be misaligned outwardly or inwardly from the mark. However, since the mark has a lower relative permittivity than the dielectric substrate, even if the antenna electrode is misaligned, there is just a small variation of the electrical length of the antenna electrode. Accordingly, it shows only a small variation in frequency characteristics with change in mounting position.

Preferably, the mark is a recess formed in the outer surface of the dielectric substrate. In this case, the recess has a relative permittivity ∈r of air, so that in the vicinity of the mark, an effective relative permittivity ∈e, which is determined by the relative permittivity ∈r of air and a relative permittivity ∈1 of the dielectric substrate, acts on the antenna electrode. Since the effective relative permittivity ∈e is, of course, lower than the relative permittivity ∈1 of the dielectric substrate, the frequency characteristics can be effectively inhibited from varying with change in mounting position of the antenna electrode.

Moreover, the mark in the form of a recess can be formed by a simple means of just scraping off the outer surface of the dielectric substrate. Furthermore, unlike other marks made of an organic or inorganic material, air will never invite change in relative permittivity due to aging, so that stable frequency characteristics can be maintained.

The present invention is widely applicable as long as the antenna is of the type having the antenna electrode formed on the surface of the dielectric substrate. Particularly, it is effectively applied to a multiple resonance antenna that is a type of λ/4 monopole antenna.

In the case of the multiple resonance antenna, the antenna electrode includes a first antenna electrode and a second antenna electrode. The first and second antenna electrodes are disposed alongside on the flexible insulating film with first ends connected in common but with second ends remaining free. The first antenna electrode is bent back to have a greater length between the first and second ends than the second antenna electrode.

When applying the present invention to the multiple resonance antenna, the mark is provided at a tip of the first or second antenna electrode or at a bend of the bent-back first antenna electrode.

In the case of the multiple resonance antenna, a balance can be achieved between high-frequency antenna characteristics and low-frequency antenna characteristics by disposing the second antenna electrode between a forward part before the bend and a backward part after the bend of the first antenna electrode.

The present invention further provides a communication device using the above-described antenna.

According to the present invention, as has been described above, it is possible to provide an antenna which shows only a small variation in frequency characteristics with change in mounting position of a FPC.

The resent invention will be more fully understood from the detailed description given hereinbelow and the accompanying drawings which are given by way of illustration only, and thus not to be considered as limiting the present invention.

### BRIEF DESCRIPTION OF THE DRAWINGS

FIG. 1 is a perspective view showing one embodiment of an antenna according to the present invention;

FIG. 2 is a sectional view taken along line II-II in FIG. 1;

FIG. 3 is a plan view showing a marked portion disposed on the antenna of FIG. 1 on an enlarged scale;

FIG. 4 is a sectional view taken along line IV-IV in FIG. 3;

FIG. 5 is a plan view of a FPC used in the antenna of FIGS. 1 to 4;

FIG. 6 is an enlarged sectional view showing one embodiment of the FPC of FIG. 5;

FIG. 7 is a plan view for illustrating the action of the mark in an antenna according to the present invention;

FIG. 8 is simulation data showing frequency-VSWR characteristics without any mark;

FIG. 9 is simulation data showing frequency-VSWR characteristics of an antenna according to the present invention;

FIG. 10 is a perspective view showing another embodiment of an antenna according to the present invention;

FIG. 11 is a plan view showing a portion of a dielectric substrate used in the antenna of FIG. 10;

FIG. 12 is a perspective view showing still another embodiment of an antenna according to the present invention;

FIG. 13 is a perspective view showing a dielectric substrate used in the antenna of FIG. 12;

FIG. 14 is a perspective view showing yet another embodiment of an antenna according to the present invention;

FIG. 15 is a perspective view showing a dielectric substrate used in the antenna of FIG. 14; and

FIG. 16 is a block diagram of a communication device using an antenna according to the present invention.

### DESCRIPTION OF THE PREFERRED EMBODIMENTS

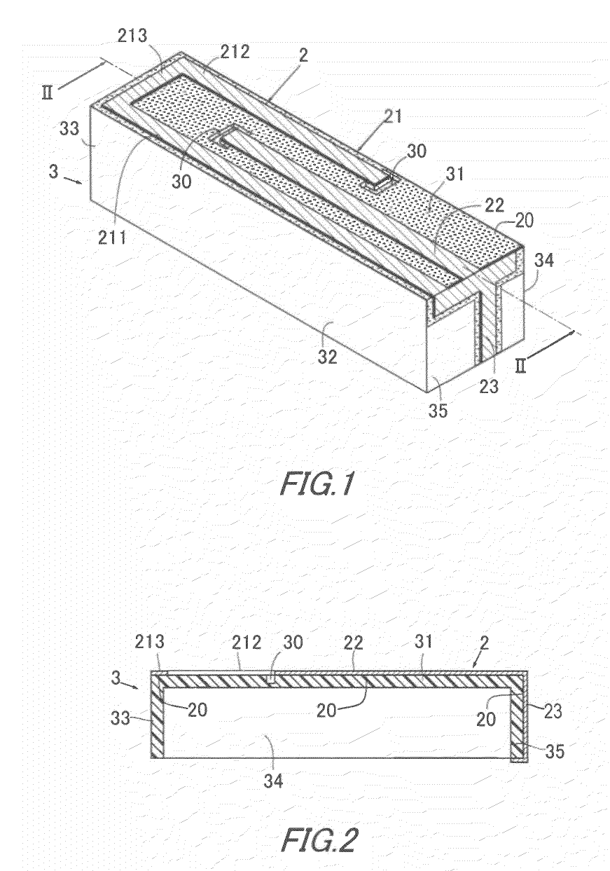

Referring first to FIGS. 1 and 2, there is illustrated a multiple resonance antenna. The multiple resonance antenna can deal with different two frequency bands even though it is a single chip, and includes an antenna element 2 and a dielectric substrate 3.

The dielectric substrate 3 is preferably made of a composite dielectric material being a mixture of a synthetic resin and dielectric ceramic powder. For example, the synthetic resin may be ABS (acrylonitrile butadiene styrene) resin or PC (polycarbonate) resin. The dielectric ceramic powder may be titanium oxide series ceramic powder or barium titanate series ceramic powder. Advantageously, the use of such a composite dielectric material makes it possible to adjust the relative permittivity of the dielectric substrate 3, form the dielectric substrate 3 into a required shape by using a molding technique, and color the dielectric substrate 3 by mixing a pigment. The relative permittivity of the dielectric substrate 3 can be adjusted by relative permittivities and composition ratio of the above-described synthetic resin and dielectric ceramic powder. For example, the relative permittivity of the dielectric substrate 3 can be set within the range of 5.5 to 8.0 by using the ABS resin and the PC resin as the synthetic resin and mixing the dielectric ceramic powder of titanium oxide (TiO₂) with the synthetic resin within the range of 45 wt % to 55 wt %.

The dielectric substrate 3 may have a solid block shape or a mostly hollow shape with outer wall surfaces. In this embodiment, the latter shape is chosen and embodied in an overall hexahedral shape which has a top panel 31 and four side panels 32 to 35 but is open at a bottom panel opposite to the top panel 31. However, the overall shape is not limited to the hexahedral shape. Other shapes may also be employed.

As a characteristic feature, the dielectric substrate 3 has marks 30 on the outer surface. The mark 30 has a relative permittivity ∈r that is lower than a relative permittivity ∈1 of the dielectric substrate 3. In this embodiment, the mark 30 is a recess formed as a C-shaped groove in the surface of the top panel 31 of the dielectric substrate 3. Therefore, the mark (recess) 30 has a relative permittivity ∈r of air.

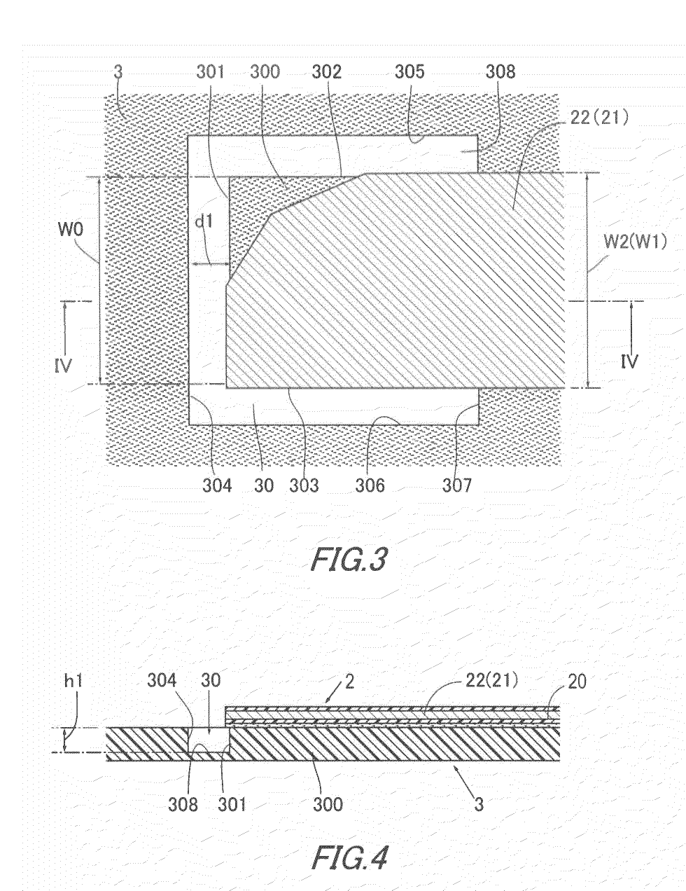

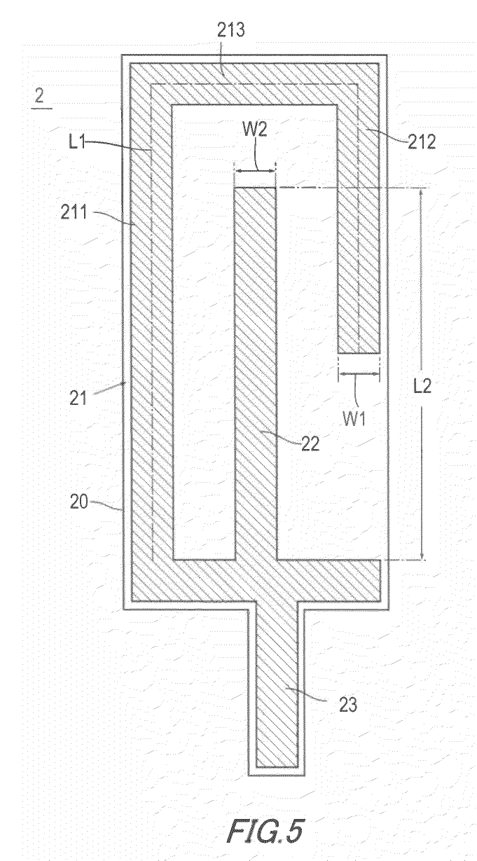

Referring to FIGS. 3 and 4, an application area 300 to which first and second antenna electrodes 21, 22 are to be adhered is enclosed on three sides by the recess forming the mark 30. The application area 300 has a front end face 301 and two side end faces 302, 303 extending rearwardly from both ends of the front end face 301. The front end face 301 and the side end faces 302, 303 serve as a positioning reference surface. These end faces 301 to 303 are opposed to outside wall surfaces 304, 304, 306 across a groove width dl. The recess forming the mark 30 terminates at a base 307 of the application area 300 and at a bottom 308. Alternatively, it may be a groove passing through the panel without any bottom 308. Taking misalignment of the FPC film into consideration, the groove width dl, a depth hl down to the bottom 308, and an occupation area of the mark (recess) 30 are dimensioned to be able to accommodate its variation. Moreover, a width W0 of the application area 300 is dimensioned to accommodate the antenna electrode.

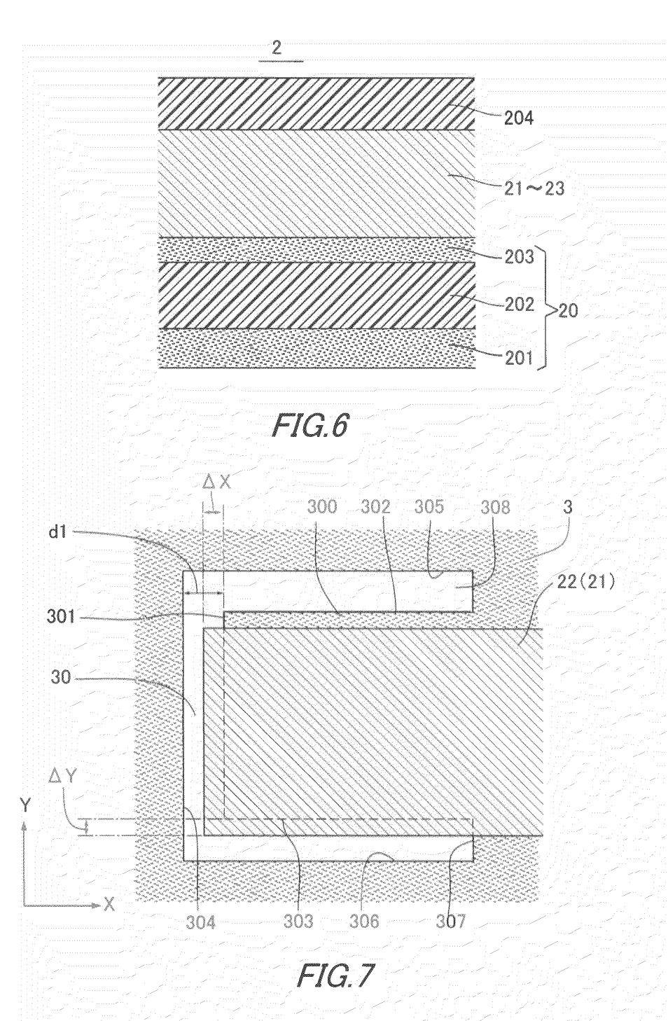

On the other hand, the antenna element 2 is formed from a FPC film. Referring to FIGS. 5 and 6 showing details thereof, the FPC film has the first and second antenna electrodes 21, 22 and a power feeding electrode 23 on one side and a flexible insulating film 20 on the other side. The flexible insulating resin film 20 is formed by stacking a first adhesive layer 201, a support film layer 202 and a second adhesive layer 203 in the named order. The first adhesive layer 201 is used for adhering the FPC film to the dielectric substrate 3, while the second adhesive layer 203 is used for adhering the first and second antenna electrodes 21, 22 and the power feeding electrode 23. The FPC film is transparent and therefore see-through at a portion where the first and second antenna electrodes 21, 22 and the power feeding electrode 23 are absent.

In detail, the first adhesive layer 201 has a layer thickness of about 50 μm, for example, the support film layer 202 is made of PET and has a layer thickness of about 25 μm, for example, and the second adhesive layer 203 has a layer thickness of about 12 μm, for example. The first and second antenna electrodes 21, 22 and the power feeding electrode 23 are made of a conductive material containing Cu as a main component and have a layer thickness of about 25 μm, for example. On the surface of the first and second antenna electrodes 21, 22 and the power feeding electrode 23, a resist layer 204 may be applied as a protective layer to have a layer thickness of about 15 μm, for example.

Referring to FIG. 5, an exemplary arrangement of the antenna electrodes is illustrated in an enlarged view. In FIG. 5, the first antenna electrode 21 and the second antenna electrode 22 are each formed as a Δ/4 monopole antenna and branch off from the power feeding electrode 23. The first antenna electrode 21 and the second antenna electrode 22 are disposed alongside on the top panel 31 of the dielectric substrate 3 while being spaced apart from each other. Of the first antenna electrode 21 and the second antenna electrode 22, first ends are connected in common, but second ends remain free. The first ends connected in common are connected to the power feeding electrode 23.

Regarding a width W1 of the first antenna electrode 21 and a width W2 of the second antenna electrode 22, for example, the width W0 of the above-described application area 300 is determined such that W0=W1, W2.

The first antenna electrode 21 has a length L1 between the first and second ends, which is greater than a length L2 of the second antenna electrode 22, and is bent back to have a forward part 211 from the first end and before the bend and a backward part 212 after the bend. The forward part 211 and the backward part 212 are continuous with each other through a bending part 213. The length L1 of the first antenna electrode 21 is a dimension measured along a centerline passing through the widthwise center.

The second antenna electrode 22 is disposed between the forward part 211 and the backward part 212 after the bend of the first antenna electrode 21. In detail, the second antenna electrode 22 is parallel to the forward part 211 of the first antenna electrode 21 at one lateral side, opposed to the bending part 213 of the first antenna electrode 21 at a tip side, and parallel to the bending part 212 of the first antenna electrode 21 at the other lateral side, wherein all the sides are spaced apart from the first antenna electrode 21.

The length L1 of the first antenna electrode 21 is determined to have an electrical length λ/4 taking into consideration its intended frequency and the relative permittivity of the dielectric substrate 3. The length L2 of the second antenna electrode 22 is determined in the same manner. For example, when the multiple resonance antenna is applied to a mobile communication device having a function of GPS (global positioning system) and a function of Bluetooth (which is a registered trademark, though not mentioned again), such as a mobile phone, GPS utilizes radio waves of 1.57 GHz band, while Bluetooth utilizes radio waves of 2.45 GHz band. Accordingly, taking into consideration the relative permittivity of the dielectric substrate 3, the length L1 of the first antenna electrode 21 is set to a dimension corresponding to the radio waves of 1.57 GHz band for GPS, while the length L2 of the second antenna electrode 22 is set to a dimension corresponding to the radio waves of 2.45 GHz band for Bluetooth.

The above-described antenna element is positioned on and adhered to the outer surface of the dielectric substrate 3 with the tips of the first and second antenna electrodes 21, 22 aligned with the marks 30. That is, the tip of the backward part 212 of the first antenna electrode 21 and the tip of the second antenna electrode 22 are each aligned with the front end face 301 of the application area 300 at the mark 30.

As described above, the antenna element 2 is formed from the FPC film, and the FPC film, which has the first and second antenna electrodes 21, 22 on one side and the flexible insulating film with the adhesive layer on the other side, is adhered to the outer surface of the dielectric substrate 3. Therefore, the antenna element 2 has a high patterning accuracy, which makes it possible to realize an antenna which shows only a small variation in its resonance frequency. In addition, it can easily be manufactured by simply adhering the FPC to the dielectric substrate 3.

Moreover, since the EPC film is positioned on and adhered to the outer surface of the dielectric substrate 3 with the first and second antenna electrodes 21, 22 aligned with the marks 30, the relative position of the first and second antenna electrodes 21, 22 to the dielectric substrate 3 can be stabilized to realize an antenna which shows only a small variation in frequency characteristics with change in mounting position of a FPC.

When aligning the tips of the first and second antenna electrodes 21, 22 with the marks 30, the tips of the first and second antenna electrodes 21, 22 may be misaligned by ΔX in a length direction X and ΔY in a width direction Y with respect to the front end face 301 and the side end faces 302, 303 of the antenna application area 300, as shown in FIG. 7.

In this embodiment, the mark 30 is a recess formed in the outer surface of the dielectric substrate 3. In this case, the mark 30 has a relative permittivity ∈r of air, so that in the vicinity of the mark 30, an effective relative permittivity ∈e, which is determined by the relative permittivity ∈r of air and a relative permittivity ∈1 of the dielectric substrate, acts on the first and second antenna electrodes 21, 22.

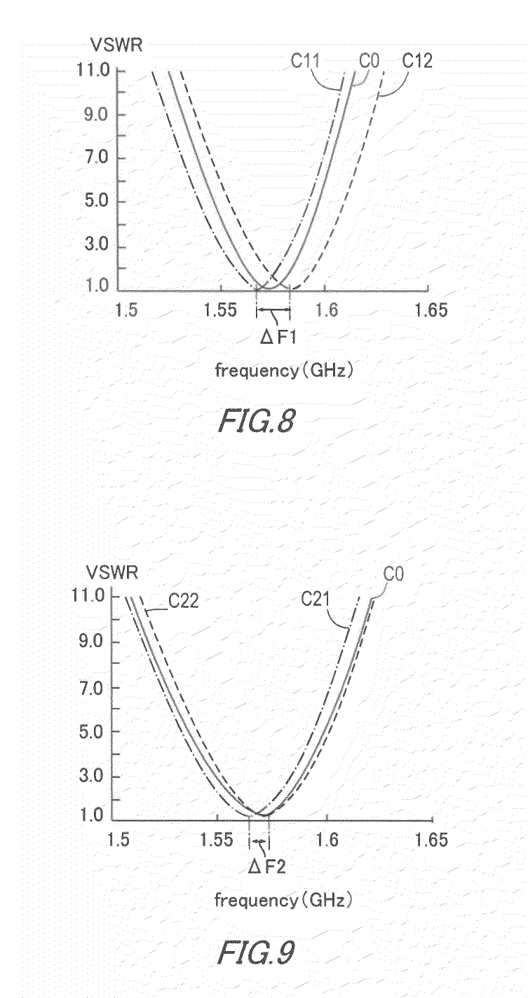

Since the effective relative permittivity ∈e is lower than the relative permittivity ∈1 of the dielectric substrate, the frequency characteristics can be effectively inhibited from varying with change in mounting position of the first and second antenna electrodes 21, 22. This will be described with reference to FIGS. 8 and 9. FIG. 8 shows frequency-VSWR (Voltage Standing Wave Ratio) characteristics of an antenna which is similar to the antenna shown in FIGS. 1 to 6 but does not have the mark 30 for comparison, while FIG. 9 shows frequency-VSWR characteristics of an antenna which is identical to the antenna shown in FIGS. 1 to 6 and has the mark 30 according to the present invention. These characteristics were obtained by shifting the FPC film from the reference position (ex. ΔY=0) in the Y axis direction by ΔY=+0.1 mm, ΔY=−0.1 mm while keeping the ΔX constant (ex. ΔX=0) in FIG. 7.

In FIG. 8, the curve CO represents the characteristics at the reference position, the curve C11 represents the characteristics when ΔY=+0.1 mm, and the curve C12 represents the characteristics when ΔY=−0.1 mm. In FIG. 9, the curve CO represents the characteristics at the reference position, the curve C21 represents the characteristics when ΔY=+0.1 mm, and the curve C22 represents the characteristics when ΔY=−0.1 mm.

As understood from comparing the characteristics of FIG. 8 with the characteristics of FIG. 9, when the FPC film was shifted within the range of ΔY=±0.1 mm, a frequency variation width ΔF2 in the case of having the mark 30 was smaller than a frequency variation width ΔF1 in the case of not having the mark 30, i.e., ΔF2<ΔF1. Thus, it is obvious that the variation of frequency characteristics with change in mounting position of the first and second antenna electrodes 21, 22 can be effectively inhibited according to the present invention.

Moreover, the recess of the mark 30 can be formed by a simple means of just scraping off the outer surface of the dielectric substrate 3. Furthermore, unlike other marks 30 made of an organic or inorganic material, air will never invite change in relative permittivity due to aging, so that stable frequency characteristics can be maintained.

The present embodiment shows a multiple resonance antenna in which the first and second antenna electrodes 21, 22 are disposed alongside on the dielectric substrate 3 with first ends connected in common but with second ends remaining free. The first antenna electrode 21 has a greater length between the first and second ends than the second antenna electrode 22. This realizes a single-chip multiple resonance antenna in which the first antenna electrode 21 serves as the low-frequency one and the second antenna electrode 22 serves as the high-frequency one.

Moreover, since the first antenna electrode 21 is bent back, a necessary physical length L1 can be secured for the first antenna electrode 21 while reducing the overall size of the dielectric substrate 3 to achieve miniaturization as a whole.

Furthermore, the second antenna electrode 22 is disposed between the forward part 211 before the bend and the backward part 212 after the bend of the first antenna electrode 21. With this configuration, excellent antenna characteristics can be secured while keeping a balance of antenna characteristics between the low-frequency first antenna electrode 21 and the high-frequency second antenna electrode 22. It should be noted that the antenna characteristics include transmitting and receiving characteristics.

Furthermore, since the physical length is increased by bending back the first antenna electrode 21, it is no more necessary to considerably increase the relative permittivity of the dielectric substrate 3. This also contributes to achieving a balance between the low-frequency antenna characteristics and the high-frequency antenna characteristics.

However, the present invention is not limited to the multiple resonance antenna illustrated as one embodiment but is widely applicable as long as it is an antenna of the type having an antenna electrode formed on the surface of the dielectric substrate 3.

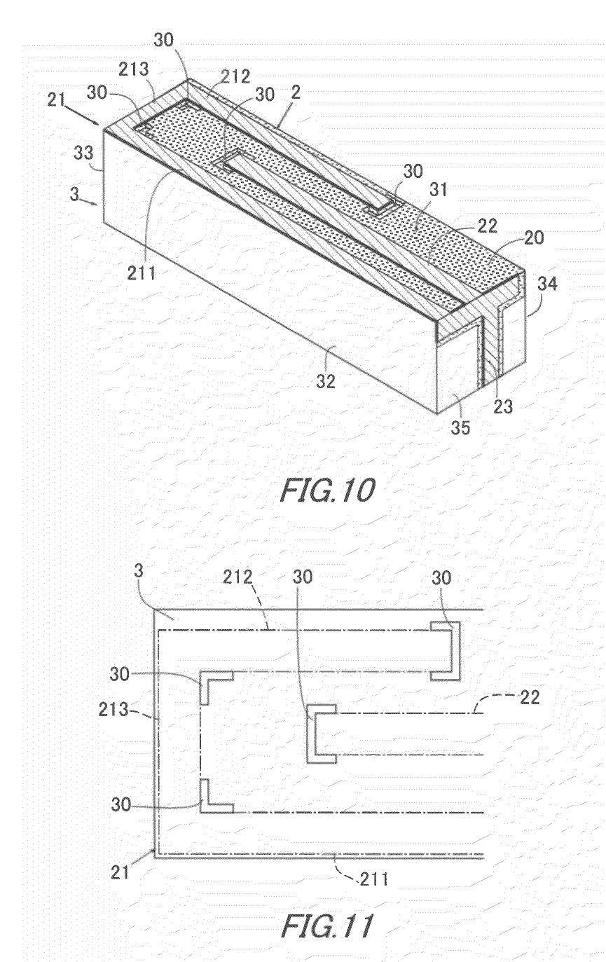

The position and form of the marks 30 may vary depending on the position and form of the first antenna electrode 21 and the second antenna electrode 22. Such other embodiments are illustrated in FIGS. 10 to 15.

Referring first to FIGS. 10 and 11, the first antenna electrode 21 and the second antenna electrode 22 are disposed as in FIGS. 1 and 2, but additional marks 30 in the form of a recess are provided inside a bend formed between the forward part 211 and the bending part 213 and inside a bend formed between the bending part 213 and the backward part 212. At the tips of the first antenna electrode 21 and the second antenna electrode 22, the marks 30 in the form of a recess are also provided in the same manner as in the embodiment of FIGS. 1 and 2.

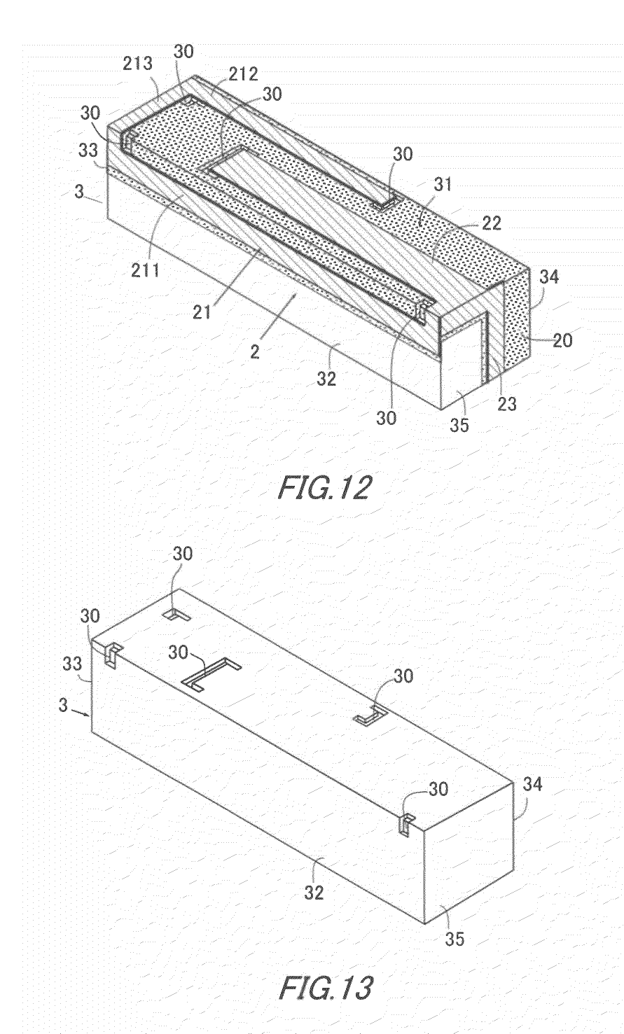

In the embodiment shown in FIGS. 12 and 13, the forward part 211 of the first antenna electrode 21 is disposed on the side panel 32 that is perpendicular to the top panel 31 having the second antenna electrode 22. The first antenna electrode 21 extends from the side panel 32 to the top panel 31 to have the backward part 212 on the top panel 31 and therefore passes through a corner of the side panel 32 and the top panel 31. At the corner of the side panel 32 and the top panel 31, accordingly, additional marks 30, 30 in the form of a recess are provided along the first antenna electrode 21.

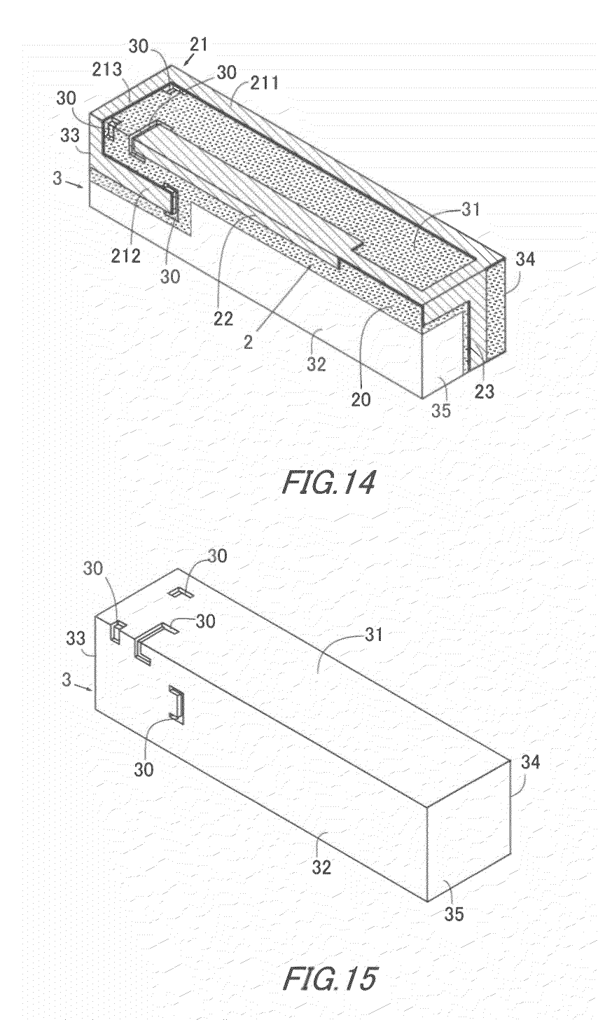

Referring next to FIGS. 14 and 15, the backward part 212 of the first antenna electrode 21 is disposed on the side panel 32 that is perpendicular to the top panel 31 having the second antenna electrode 22. A half of the width of the second antenna electrode 22 is disposed on the top panel 31, and the rest is disposed on the side panel 32. The vicinity of widthwise center of the second antenna electrode 22 lies on the corner of the top panel 31 and the side panel 32. At the corner of the side panel 32 and the top panel 31, accordingly, additional marks 30, 30 in the form of a recess are provided along the first antenna electrode 21 and the tip of the second antenna electrode 22.

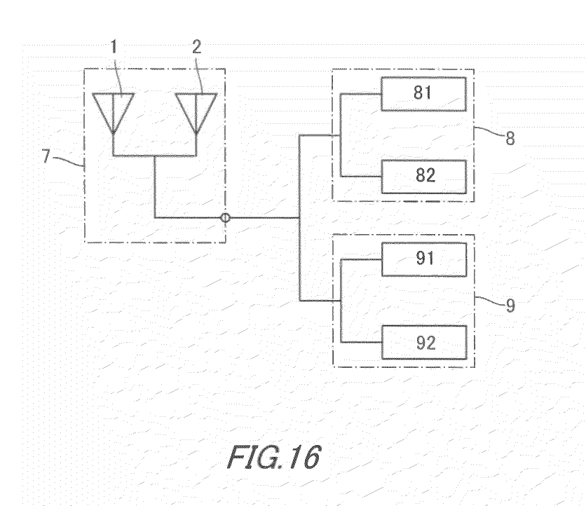

The present invention further provides a communication device using the above-described antenna. FIG. 16 shows one embodiment. The illustrated communication device includes a multiple resonance antenna 7 according to the present invention, a low-frequency communication unit 8 and a high-frequency communication unit 9.

The antenna 7 includes the first antenna electrode 21 and the second antenna electrode 22. Details are the same as described above. The power feeding path of the antenna 7 is connected to an input-output side of the low-frequency communication unit 8 and the high-frequency communication unit 9. For example, the low-frequency communication unit 8 has a function of GPS, while the high-frequency communication unit 9 has a function of Bluetooth. It should be noted that “low-frequency” and “high-frequency” are relative expression. The low-frequency communication unit 8 has a transmitting circuit 81 and a receiving circuit 82, and the high-frequency communication unit 9 has a transmitting circuit 91 and a receiving circuit 92. Although not shown in the figure, of course, circuit elements necessary for a communication device of this type should be added thereto.

While the present invention has been particularly shown and described with respect to preferred embodiments thereof, it will be understood by those skilled in the art that various changes in form and detail may be made therein without departing from the spirit, scope and teaching of the invention.

What is claimed is:

1. An antenna comprising a dielectric substrate and an antenna element, wherein
the dielectric substrate has a mark on an outer surface, the mark having a lower relative permittivity than the dielectric substrate,
the antenna element is formed from a FPC film, and
the FPC film has an antenna electrode on one side and a flexible insulating film with an adhesive layer on the other side and is adhered to the outer surface of the dielectric substrate with a tip or a bend of the antenna electrode aligned with the mark.

2. The antenna of claim 1, wherein the mark is a recess formed in the outer surface of the dielectric substrate.

3. The antenna of claim 1, wherein the dielectric substrate is made of a composite dielectric material containing a synthetic resin and ceramic powder.

4. The antenna of claim 1, wherein the antenna electrode includes a first antenna electrode and a second antenna electrode,
the first and second antenna electrodes are disposed alongside on the flexible insulating film with first ends connected in common but with second ends remaining free, and
the first antenna electrode is bent back to have a greater length between the first and second ends than the second antenna electrode.

5. The antenna of claim 4, wherein the second antenna electrode is disposed between a forward part before the bend and a backward part after the bend of the first antenna electrode.

6. A communication device comprising an antenna and a communication circuit, wherein
the antenna includes a dielectric substrate and an antenna element,
the dielectric substrate has a mark on an outer surface, the mark having a lower relative permittivity than the dielectric substrate,
the antenna element is formed from a FPC film,
the FPC film has an antenna electrode on one side and a flexible insulating film with an adhesive layer on the other side and is adhered to the outer surface of the dielectric substrate with a tip or a bend of the antenna electrode aligned with the mark, and
the communication circuit is connected to the antenna.

7. The communication device of claim 6, wherein the mark is a recess formed in the outer surface of the dielectric substrate.

8. The communication device of claim 6, wherein the dielectric substrate is made of a composite dielectric material containing a synthetic resin and ceramic powder.

9. The communication device of claim 6, wherein the antenna electrode includes a first antenna electrode and a second antenna electrode,
the first and second antenna electrodes are disposed alongside on the flexible insulating film with first ends connected in common but with second ends remaining free, and
the first antenna electrode is bent back to have a greater length between the first and second ends than the second antenna electrode.

10. The communication device of claim 9, wherein the second antenna electrode is disposed between a forward part before the bend and a backward part after the bend of the first antenna electrode.
